(19) United States
(12) Patent Application Publication
(10) Pub. No.: US 2008/0121352 A1
(43) Pub. Date: May 29, 2008

(54) Roll-up barrier

(76) Inventor: Shu-Chen Cheng, Tamshui Chen (TW)

Correspondence Address: COOPER & DUNHAM, LLP, 1185 AVENUE OF THE AMERICAS, NEW YORK, NY, 10036, US

(21) Appl. No.: 11/604,993

(22) Filed: Nov. 28, 2006

(51) Int. Cl. E06B 9/08

(52) U.S. Cl. 160/238

(57) ABSTRACT

A roll-up barrier has a base, an end cap, a drive shaft, a rolling assembly, a resilient element and a flexible barrier. The drive shaft is connected between the base and the end cap. The rolling assembly has a rolling tube and a rolling bushing. The rolling tube is mounted rotatably around the drive shaft and has a top end. The rolling bushing is connected securely to the top end of the rolling tube. The resilient element is connected to the drive shaft and the rolling bushing and pushes the rolling bushing up. The flexible barrier is attached to and mounted retractably around the rolling tube. The roll-up barrier has a structure that is simple and makes fabrication and assembly of the roll-up barrier easy and convenient.

### BACKGROUND OF THE INVENTION

1. Field of the Invention

The present invention relates to a roll-up barrier, and more particular to a roll-up barrier that has a simple structure and improves operating convenience.

2. Description of Related Art

A safe zone in which an infant or a pet can play to limit access to hazardous areas is defined with a temporary barrier or gate mounted between two walls or in a doorway.

For make storage convenient, various kinds of roll-up barriers have been developed. Generally, a conventional roll-up barrier has a base, a bottom spring housing, a drive shaft, a top spring housing, a end cap, a bottom torsion spring, a top torsion spring and a flexible barrier.

The bottom spring housing is mounted securely on the base and has a top surface and a connecting tube. The connecting tube is formed on and protrudes up from the top surface of the bottom spring housing.

The drive shaft is hollow and has a bottom end and a top end. The bottom end of the drive shaft is mounted rotatably around the connecting tube of the bottom spring housing.

The top spring housing has a bottom and a connecting tube. The connecting tube is formed on and protrudes down from the bottom of the top spring housing and is rotatably held in the top end of the drive shaft.

The end cap is mounted securely on the top spring housing.

The bottom torsion spring is mounted in the bottom spring housing around the connecting tube of the bottom spring housing and has a proximal end and a distal end. The proximal end is connected securely to the bottom spring housing. The distal end is connected securely to the bottom end of the drive shaft.

The top torsion spring is mounted in the top spring housing around the connecting tube of the top spring housing and has a proximal end and a distal end. The proximal end is connected securely to the top spring housing. The distal end is connected securely to the top end of the drive shaft.

The flexible barrier is mounted retractably around the drive shaft and has a proximal edge connected to the drive shaft and a distal edge.

The roll-up barrier can be attached to a wall or doorjamb, and the distal edge of the flexible barrier can be pulled out and attached to an adjacent wall opposite or doorjamb. Thus, the flexible barrier forms a barrier between the walls or doorjambs to define a safe zone in which an infant or pet can play. When the distal edge of the flexible barrier is released, the bottom torsion spring and the top torsion spring rotate the drive shaft to retract and roll the flexible barrier around the drive shaft.

However, when the drive shaft rotates, elements above the bottom spring housing press the bottom end of the drive shaft against the bottom spring housing and generates friction, which prevents the flexible barrier from being smoothly pulled out. Further, structure of the roll-up barrier is complicated and is hard to fabricate or assemble.

Therefore, the invention provides a roll-up barrier to mitigate or obviate the aforementioned problems.

### SUMMARY OF THE INVENTION

The primary objective of the present invention is to provide a roll-up barrier that has a simple structure, is convenient to assemble and can be operated smoothly.

The roll-up barrier in accordance with the present invention has a base, an end cap, a drive shaft, a rolling assembly, a resilient element and a flexible barrier. The drive shaft is connected between the base and the end cap. The rolling assembly has a rolling tube and a rolling bushing. The rolling tube is mounted rotatably around the drive shaft and has a top end. The rolling bushing is connected securely to the top end of the rolling tube. The resilient element is connected to the drive shaft and the rolling bushing and pushes the rolling bushing up. The flexible barrier is attached to and mounted retractably around the rolling tube. The roll-up barrier has a structure that is simple and makes fabrication and assembly of the roll-up barrier easy and convenient.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a roll-up barrier in accordance with the present invention;

FIG. 2 is an exploded perspective view of the roll-up barrier in FIG. 1;

FIG. 3 is an enlarged exploded perspective view of the roll-up barrier in FIG. 1;

FIG. 4 is an operational perspective view of the roll-up barrier in FIG. 1.

### DETAILED DESCRIPTION OF THE PREFERRED EMBODIMENT

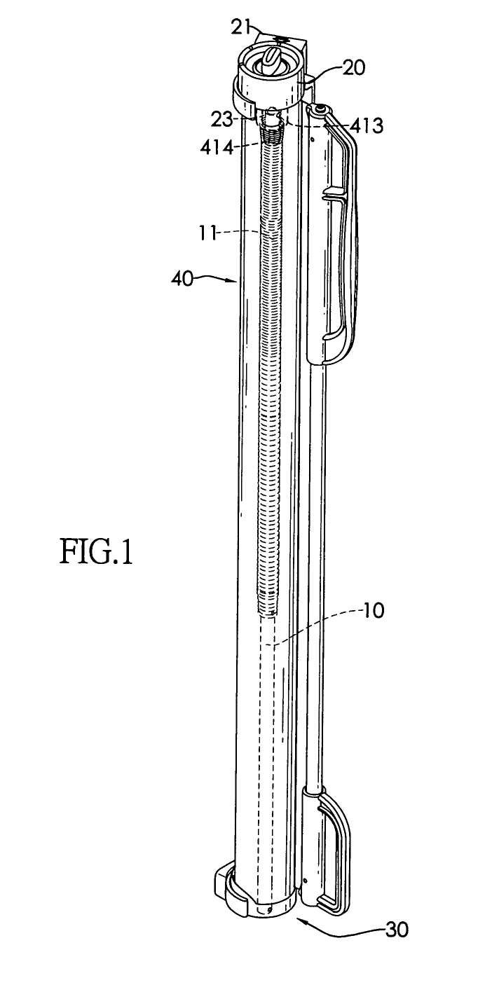

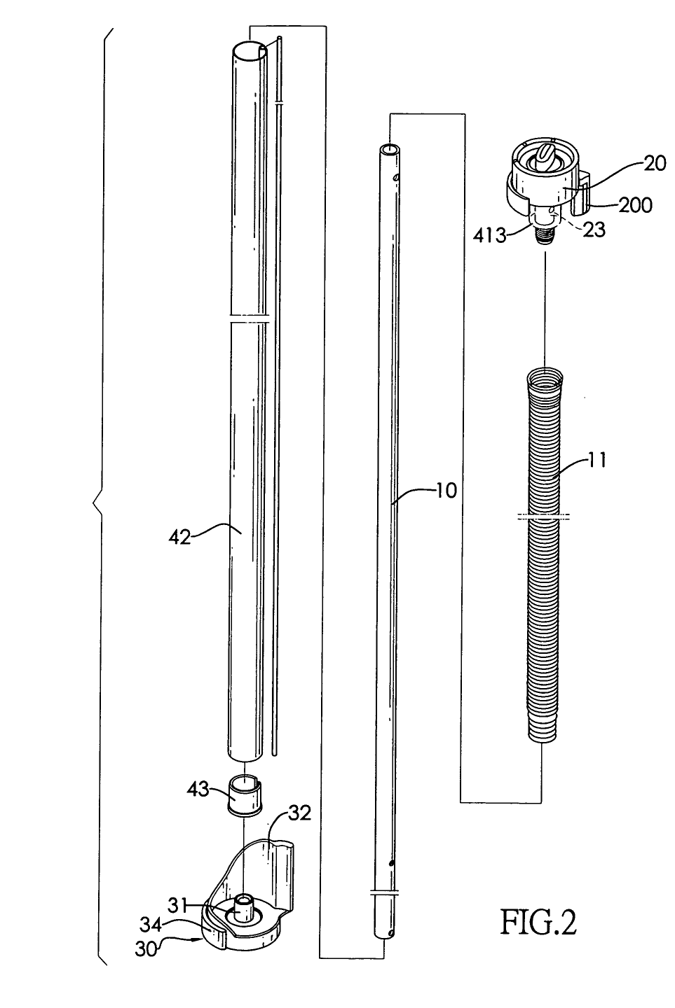

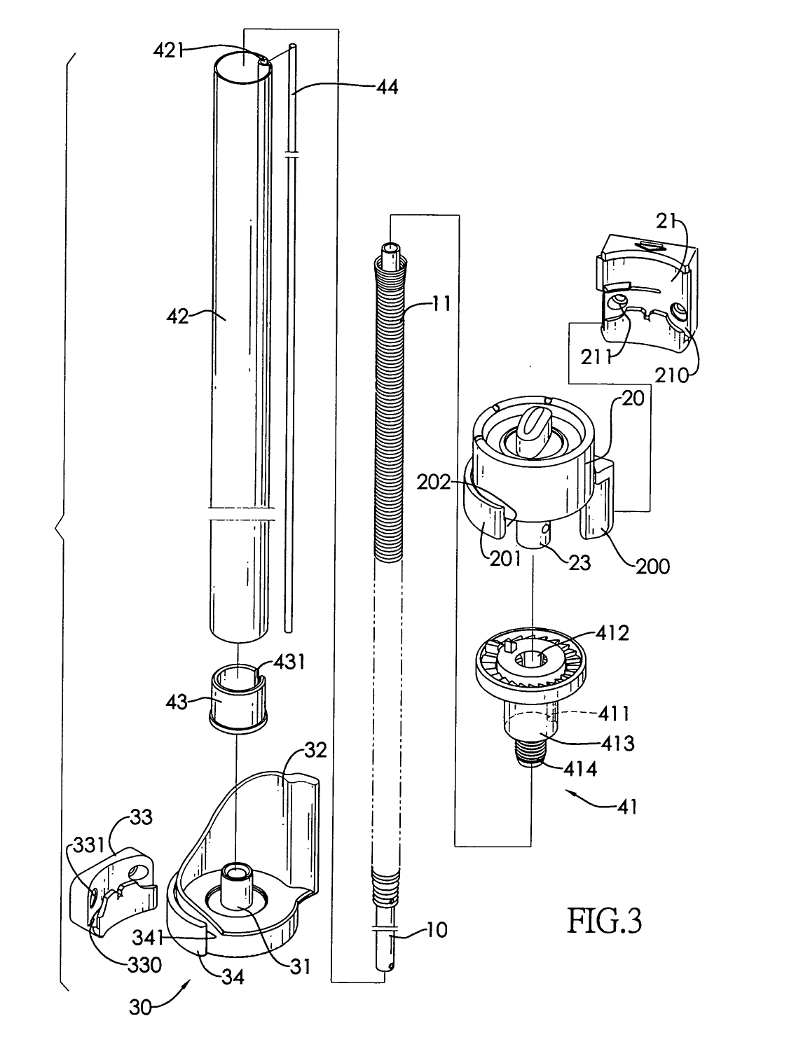

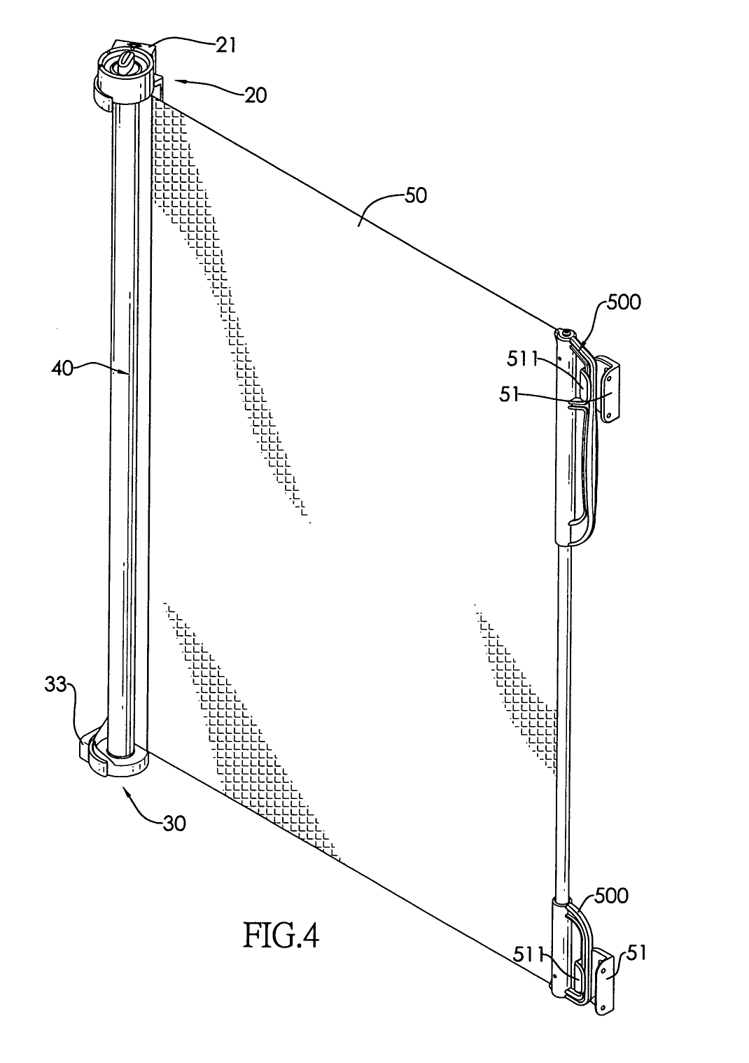

With reference to FIGS. 1, 2 and 4, a roll-up barrier in accordance with the present invention comprises a base (30), a drive shaft (10), an end cap (20), a rolling assembly (40), a resilient element (11) and a flexible barrier (50). The base (30) has a top surface, an outer edge, a connecting tube (31), an optional guide tab (32), an optional connecting lip (34) and an optional base connector (33). The connecting tube (31) is formed on and protrudes up from the top surface of the base (30). The guide tab (32) is formed on and protrudes up from the top surface of the base (30) and is mounted around the connecting tube (31). With further reference to FIG. 3, the connecting lip (34) is curved, is mounted around the outer edge of the base (30), forms a curved gap (341) between the outer edge of the base (30) and the connecting lip (34) and has a proximal end. The proximal end of the connecting lip (34) is formed on and protrudes radially from the outer edge of the base (30). The base connector (33) attaches to a stationary, e.g. a wall, a doorjamb or the like and has an inside surface, multiple through holes (331), multiple fasteners and a connecting groove (330). The through holes (331) are formed transversely through the base connector (33). The fasteners extend respectively through the through holes (331) and attach to a stationary, e.g. a wall, a doorjamb or the like to connect the base connector (33) to the stationary. The connecting groove (330) is formed in the inside surface of the base connector (33) to selectively hold the connecting lip (34) of the base (30) to mount the base (30) on the base connector (33).

The drive shaft (10) has a bottom end, and a top end. The bottom end of the drive shaft (10) is mounted securely in the connecting tube (31) of the base (30).

The end cap (20) is mounted securely at the top end of the drive shaft (10) and has a bottom surface, an outer edge, a connecting tube (23), an optional guide tab (200), an optional connecting lip (201) and an optional end cap connector (21). The connecting tube (23) is formed coaxially on and protrudes down from the bottom surface of the end cap (20) and securely holds the top end of the drive shaft (10). The guide tab (200) is formed on and protrudes down from the bottom surface of the end cap (20) and is mounted around the connecting tube (23). The connecting lip (201) is curved, is mounted around the outer edge of the end cap (20), defines a curved gap (202) between the outer edge of the end cap (20) and the connecting lip (201) and has a proximal end. The proximal end of the connecting lip (201) is formed on and protrudes radially from the outer edge of the end cap (20). The end cap connector (21) connects to the stationary, e.g. a wall, a doorjamb or the like to which the base connector (33) is connected and has an inside surface, multiple through holes (211), multiple fasteners and a connecting groove (210). The through holes (211) are formed transversely through the end cap connector (21). The fasteners extend respectively through the through holes (211) and attach to the stationary to attach the end cap connector (21) to the stationary. The connecting groove (210) is formed in the inside surface of the end cap connector (21) to selectively hold the connecting lip (201) of the base (30) to mount the end cap (20) on the end cap connector (21).

The rolling assembly (40) is mounted rotatably between the base (30) and the end cap (20) and has an optional connecting bushing (43), a rolling tube (42) and a rolling bushing (41).

The connecting bushing (43) is mounted rotatably on the base (30) around the connecting tube (31) and has a top edge and a keyway (431). The keyway (431) is formed longitudinally through the connecting bushing (41) and communicates with the top edge of the connecting bushing (41).

The rolling tube (42) is mounted rotatably around the drive shaft (10) and has an inner surface, an outer surface, a bottom end, a top end, an optional mounting groove (421) and an optional mounting rod (44).

The bottom end of the rolling tube (42) is mounted rotatably on the base (30) around the connecting tube (31) and may be connected securely to the connecting bushing (41) to mount the rolling tube (42) rotatably on the base (30).

The mounting groove (421) is formed longitudinally in the outer surface of the rolling tube (42) and protrudes in from the inner surface of the rolling tube (42) to form a longitudinal rib. The longitudinal rib has a bottom end and a top end. The bottom end of the longitudinal rib is held in the keyway (431) in the connecting bushing (41) to securely connect the rolling tube (42) to the connecting bushing (41). The mounting rod (44) is mounted in the mounting groove (421).

The rolling bushing (41) is mounted securely at the top end of the rolling tube (42) and has a cylinder (413), a mounting nipple (414) and a connecting hole (412). The cylinder (413) is mounted securely in the top end of the rolling tube (42) and has an outer surface, a bottom and an optional keyway (411). The keyway (411) is formed longitudinally in the outer surface of the cylinder (413) and holds the top end of the longitudinal rib formed by the mounting groove (421) extending into the rolling tube (42). The mounting nipple (414) is formed on and protrudes down coaxially from the bottom of the cylinder (413) and has an outer surface and an optional outer thread. The outer thread is formed on the outer surface of the mounting nipple (414). The connecting hole (412) is formed coaxially through the cylinder (413) and the mounting nipple (414) and is rotatably mounted around the drive shaft (10).

The resilient element (11) is mounted around and connected securely to the drive shaft (10), is connected to and presses the rolling bushing (41) up slightly, which lifts the rolling tube (42) away from the base (30), and has a bottom end and a top end. The bottom end of the resilient element (11) is connected securely to the drive shaft (10). The top end of the resilient element (11) is connected securely to the mounting nipple (414) on the rolling bushing (41) and may screw onto the outer thread on the mounting nipple (414).

Pushing the rolling bushing (41), the rolling tube (42) and the connecting bushing (43) upward significantly reduces friction between the connecting bushing (43) and the top surface of the base (30). Less friction facilitates smooth rotation of the rolling assembly (40).

The flexible barrier (50) is attached to and mounted retractably around the rolling tube (42) and has a proximal edge, a distal edge, a bottom edge, a top edge, two optional handles (500) and two optional connectors (51). The proximal edge of the flexible barrier (50) is attached to the rolling tube (42) and may be attached to the mounting rod (44) mounted in the mounting groove (421) in the rolling tube (42). The bottom edge of the flexible barrier (50) is guided by the guide tab (32) on the base (30), and the top edge of the flexible barrier (50) is guided by the guide tab (200) on the end cap (20) such that the flexible barrier (50) can be pulled out smoothly.

The handles (500) are mounted on the distal edge of the flexible barrier (50) respectively near the top and bottom edges of the flexible barrier (50).

The connectors (51) connect to an adjacent stationary, e.g. a wall, a doorjamb or the like and align respectively with and selectively engage the handles (500) to hold the flexible barrier (50) in an extended position, and each connector (51) has an inside surface and a hook (511). The hook (511) is formed on and protrudes from the inside surface of the connector (51) to selectively hook the corresponding handle (500).

When the handles (500) are released from the hooks (511) on the connectors (51), potential energy stored in the resilient element (11) when the flexible barrier (50) is pulled out rotates the rolling assembly (40) and retracts the flexible barrier (50) by rolling the flexible barrier (50) back around the rolling tube (42).

The primary advantages of the roll-up barrier are its simple design and ease of operation. The design fundamentally has only three moving parts, the rolling tube (42), the resilient element (11) and the flexible barrier (50), which results in very simple and easy fabrication and assembly and reduced fabrication and assembly cost. The arrangement of the resilient element (11) relative to the drive shaft (10) and the rolling tube (42) results in virtually no friction between the rolling tube (42) and the base (30) so extending and retracting the flexible barrier (50) is very smooth Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A roll-up barrier comprising:
a base having
a top surface;
an outer edge; and
a connecting tube being formed on and protruding up from the top surface of the base;
a drive shaft having
a bottom end mounted securely in the connecting tube of the base; and
a top end;
an end cap being mounted securely at the top end of the drive shaft and having
a bottom surface;
an outer edge; and
a connecting tube being formed coaxially on and protruding down from the bottom surface of the end cap and securely holding the top end of the drive shaft;
a rolling assembly being mounted rotatably between the base and the end cap and having;
a rolling tube being mounted rotatably around the drive shaft and having
an inner surface;
an outer surface;
a bottom end being mounted rotatably on the base around the connecting tube of the base; and
a top end; and
a rolling bushing being mounted securely at the top end of the rolling tube and having
a cylinder being mounted securely in the top end of the rolling tube and having
an outer surface; and
a bottom;
a mounting nipple being formed on and protruding coaxially down from the bottom of the cylinder and having an outer surface; and
a connecting hole being formed coaxially through the cylinder and the mounting nipple and rotatably mounted around the drive shaft;
a resilient element being mounted around and connected securely to the drive shaft, being connected to and pressing the rolling bushing up slightly and having
a bottom end being connected securely to the drive shaft; and
a top end being connected securely to the mounting nipple; and
a flexible barrier being attached to and mounted retractably around the rolling tube and having
a proximal edge being attached to the rolling tube;
a distal side;
a bottom edge; and
a top edge.

2. The roll-up barrier as claimed in claim 1, wherein
the base further has
a connecting lip being curved, mounted around the outer edge of the base, forming a curved gap between the outer edge of the base and the connecting lip and having a proximal end formed on and protruding radially from the outer edge of the base; and
a base connector having
an inside surface;
multiple through holes formed transversely through the base connector; and
a connecting groove formed in the inside surface of the base connector to selectively hold the connecting lip of the base; and
the end cap further has
a connecting lip being curved, mounted around the outer edge of the end cap, defining a curved gap between the outer edge of the end cap and the connecting lip and having a proximal end formed on and protruding radially from the outer edge of the end cap; and
an end cap connector having
an inside surface;
multiple mounting holes formed transversely through the end cap connector; and
a connecting groove formed in the inside of the end cap connector to selectively hold the connecting lip of the base.

3. The roll-up barrier as claimed in claim 2, wherein
the base further has a guide tab formed on and protruding up from the top surface of the base and mounted around the connecting tube;
the bottom edge of the flexible barrier is guided by the guide tab on the base;
the end cap further has a guide tab formed on and protruding down from the bottom surface of the end cap and mounted around the connecting tube; and
the top edge of the flexible barrier is guided by the guide tab on the end cap.

4. The roll-up barrier as claimed in claim 1, wherein
the rolling assembly further has a connecting bushing mounted rotatably on the base around the connecting tube and having
a top edge; and
a keyway formed longitudinally through the connecting bushing and communicating with the top edge;
the bottom end of the rolling tube is connected securely to the connecting bushing;
the rolling tube further has
a mounting groove formed longitudinally in the outer surface of the rolling tube and protruding in from the inner surface of the rolling tube to form a longitudinal rib, the longitudinal rib having
a bottom end held in the keyway in the connecting bushing; and
a top end;
a mounting rod mounted in the mounting groove;
the cylinder of the rolling bushing further has a keyway formed longitudinally in the outer surface of the cylinder and holding the top end of the longitudinal rib formed by the mounting groove extending into the rolling tube; and
the proximal edge of the flexible barrier is attached to the mounting rod of the rolling tube.

5. The roll-up barrier as claimed in claim 1 further comprising
two handles mounted on the distal edge of the flexible barrier respectively near the top and bottom edges of the flexible barrier; and
two connectors aligning with and selectively engaging the handles, and each connector having
an inside surface; and
a hook formed on and protruding from the inside surface of the connector to selectively hook a corresponding one of the handles.

6. The roll-up barrier as claimed in claim 1, wherein
the mounting nipple of the rolling bushing further has an outer thread formed on the outer surface of the mounting nipple; and
the top end of the resilient element screws onto the outer thread on the mounting nipple.
